(19) United States
(12) Patent Application Publication
(10) Pub. No.: US 2025/0322516 A1
(43) Pub. Date: Oct. 16, 2025

(54) IMAGE PROCESSING APPARATUS, IMAGE PROCESSING METHOD, AND RECORDING MEDIUM

(71) Applicants: Canon Kabushiki Kaisha, Tokyo (JP); CANON MEDICAL SYSTEMS CORPORATION, Tochigi (JP)

(72) Inventors: Toshimizu YAMANE, Shinagawa-ku (JP); Kiyohide SATOH, Kawasaki-shi (JP); Nobuhiro ITO, Yamato-shi (JP)

(73) Assignees: Canon Kabushiki Kaisha, Tokyo (JP); CANON MEDICAL SYSTEMS CORPORATION, Tochigi (JP)

(21) Appl. No.: 19/175,504

(22) Filed: Apr. 10, 2025

(30) Foreign Application Priority Data
Apr. 10, 2024 (JP) 2024-063662

(51) Int. Cl. G06T 7/00; G06T 3/40; G06T 3/60; G06T 5/50; G06V 10/25; G06V 10/75

(52) U.S. Cl. CPC G06T 7/0012; G06T 3/40; G06T 3/60; G06T 5/50; G06V 10/25; G06V 10/751; G06T 2207/20224; G06T 2207/30012

(57) ABSTRACT

An image processing apparatus according to one embodiment includes processing circuitry is configured to acquire a first image and a second image that are obtained by imaging a subject at different times, acquire identification information on a part at a plurality of coordinates in the first image, and generate a subtraction image between the first image and the second image such that a corrected subtraction value, that is obtained by performing a predetermined correction process, is adopted as a pixel value of a pixel of interest, the predetermined correction process being performed on an initial subtraction value that represents a difference between a pixel value at a first coordinate in the first image corresponding to the pixel of interest and a pixel value at a second coordinate in the second image corresponding to the first coordinate, when the pixel of interest is identified as a first part based on the identification information, the predetermined correction process corresponding to a determination result of determination on whether or not the pixel value at the first coordinate and the pixel value at the second coordinate meet a predetermined condition.

### CROSS-REFERENCE TO RELATED APPLICATIONS

This application is based upon and claims the benefit of priority from Japanese Patent Application No. 2024-063662, filed on Apr. 10, 2024; the entire contents of which are incorporated herein by reference.

### FIELD

Embodiments described herein relate generally to an image processing apparatus, an image processing method, and a recording medium.

### BACKGROUND

It is possible to evaluate a temporal change of a lesion or the like by acquiring medical images at a plurality of times. Further, it is possible to assist diagnosis more effectively by generating a subtraction image in which a temporal change of a lesion or the like is visualized based on medical images at a plurality of times.

### BRIEF DESCRIPTION OF THE DRAWINGS

FIG. 1 is a diagram illustrating a configuration of an image processing system according to a first embodiment;

FIG. 2 is a flow diagram illustrating the flow of an entire process in the first embodiment;

FIG. 3A is a diagram illustrating an example of a two-dimensional cross-sectional image in the first embodiment;

FIG. 3B is a diagram illustrating identification information on a part in a first medical image;

FIG. 4 is a flow diagram illustrating the flow of a process performed by a subtraction image generation unit 104;

FIG. 5 is a diagram illustrating a configuration of an image processing system according to a second embodiment;

FIG. 6 is a flow diagram illustrating the flow of an entire process in the second embodiment;

FIG. 7 is a diagram illustrating a configuration of an image processing system according to a third embodiment;

FIG. 8 is a flow diagram illustrating the flow of an entire process in the third embodiment;

FIG. 9A is a diagram for explaining conditional branch for performing a correction process by a subtraction image correction unit according to the third embodiment and correction process operation;

FIG. 9B is a diagram for explaining an example of a correction process including an attenuation process based on a predetermined threshold of zero according to the third embodiment;

FIG. 9C is a diagram for explaining an example of a correction process including an attenuation process based on a predetermined negative threshold according to the third embodiment;

FIG. 9D is a diagram for explaining an example of a correction process including an attenuation process based on a predetermined positive threshold according to the third embodiment;

FIG. 10 is a diagram illustrating a configuration of an image processing system according to a fourth embodiment;

FIG. 11A is a diagram for explaining conditional branch for performing a correction process by a subtraction image correction unit according to the fourth embodiment and correction process operation; and

FIG. 11B is a diagram for explaining correction process operation for performing a subtraction image correction process in which a display mode is changed according to the fourth embodiment.

### DETAILED DESCRIPTION

An image processing apparatus according to one embodiment includes an image acquisition means that acquires a first image and a second image that are obtained by imaging a subject at different times, an identification information acquisition means that acquires identification information on a part at a plurality of coordinates in the first image, and a subtraction image generation means that generates a subtraction image between the first image and the second image such that a corrected subtraction value, that is obtained by performing a predetermined correction process, is adopted as a pixel value of a pixel of interest, the predetermined correction process being performed on an initial subtraction value that represents a difference between a pixel value at a first coordinate in the first image corresponding to the pixel of interest and a pixel value at a second coordinate in the second image corresponding to the first coordinate, when the pixel of interest is identified as a first part based on the identification information, the predetermined correction process corresponding to a determination result of determination on whether or not the pixel value at the first coordinate and the pixel value at the second coordinate meet a predetermined condition.

An image processing method according to one embodiment includes acquiring a first image and a second image that are obtained by imaging a subject at different times, acquiring identification information on a part at a plurality of coordinates in the first image, generating a subtraction image between the first image and the second image such that a corrected subtraction value, that is obtained by performing a predetermined correction process, is adopted as a pixel value of a pixel of interest, the predetermined correction process being performed on an initial subtraction value that represents a difference between a pixel value at a first coordinate in the first image corresponding to the pixel of interest and a pixel value at a second coordinate in the second image corresponding to the first coordinate, when the pixel of interest is identified as a first part based on the identification information, the predetermined correction process corresponding to a determination result of determination on whether or not the pixel value at the first coordinate and the pixel value at the second coordinate meet a predetermined condition.

An image processing apparatus according to one embodiment includes an image acquisition unit that acquires a first image and a second image that are obtained by imaging a same subject at different times, an image adjustment unit that adjusts at least one of the first image and the second image such that one of the first image and the second image is made corresponding to another one of the first image and the second image, a subtraction image generation unit generates a subtraction image by calculating a subtraction value of an image for which an imaging time is temporally later with respect to an image for which an imaging time is temporally earlier between the adjusted image and the other image, an identification information acquisition unit that extracts an anatomical part from at least any of the temporally later image and the subtraction image and acquires identification information on the anatomical part, and a subtraction image correction unit that corrects the subtraction image based on a correction method corresponding to the identification information. The subtraction image correction unit performs correction in accordance with whether or not the identification information on a pixel of interest in the subtraction image is a first part and whether or not a pixel value of the subtraction image is smaller than a predetermined threshold.

The image processing method according to one embodiment includes an image acquisition process of acquiring a first image and a second image that are obtained by imaging a same subject at different times, an image adjustment process of adjusting at least one of the first image and the second image such that one of the first image and the second image is made corresponding to another one of the first image and the second image, a subtraction image generation process of generating a subtraction image by calculating a subtraction value of an image for which an imaging time is temporally later with respect to an image for which an imaging time is temporally earlier between the adjusted image and the other image, an identification information acquisition process of extracting an anatomical part from at least any of the temporally later image and the subtraction image and acquiring identification information on the anatomical part, and a subtraction image correction process of correcting the subtraction image based on a correction method corresponding to the identification information. The subtraction image correction process performs correction in accordance with whether or not the identification information on a pixel of interest in the subtraction image is a first part and whether or not a pixel value of the subtraction image is smaller than a predetermined threshold.

Embodiments will be described in detail below with reference to the accompanying drawings. Meanwhile, the invention recited in claims is not limited by the embodiments described below. A plurality of features are described in the embodiments; however, all of the features are not always needed for the invention, and the features may be arbitrarily combined. In addition, in the accompanying drawings, the same or similar components are denoted by the same reference symbols, and repeated explanation will be omitted.

### First Embodiment

An image processing apparatus according to a first embodiment is an apparatus that generates a subtraction image or the like between two images (a first medical image and a second medical image) that are captured at different times. For example, the image processing apparatus performs deformed registration between two images and generates a subtraction image by a calculation method that corresponds to a part.

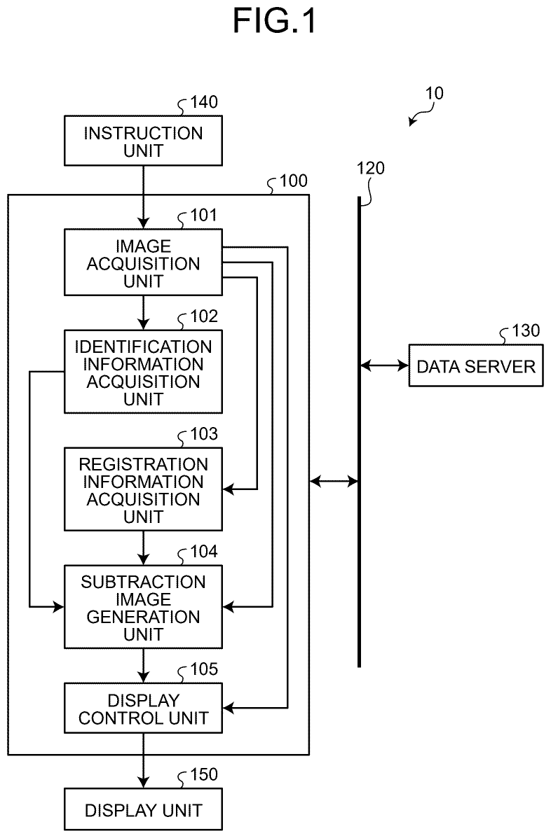

FIG. 1 is a diagram illustrating a configuration of an image processing system 10 according to the first embodiment. The image processing system 10 includes an image processing apparatus 100, a data server 130, and a display unit 150.

The image processing apparatus 100 is an apparatus that generates a subtraction image or the like between two images that are captured at different times. The image processing apparatus 100 includes a communication interface 10IF (not illustrated) for connecting to the data server 130 via a communication network 120.

The data server 130 stores therein a plurality of medical images. The data server 130 represents, for example, a Picture Archiving and Communication System (PACS) that receives medical image data that is captured by modality and stores and manages the medical image data via a network. In the following description, it is assumed that the data server 130 stores therein, as the first medical image and the second medical image, a plurality of three-dimensional tomographic images that are obtained by capturing a subject at different times in advance. In the present embodiment, explanation will be given based on the assumption that, as an example of the medical image, the first medical image and the second medical image are three-dimensional tomographic images (three-dimensional medical images) that are obtained by image capturing performed by an X-ray Computed Tomography (CT) apparatus.

The modality that captures the three-dimensional tomographic images may be a Magnetic Resonance Imaging (MRI) apparatus, a three-dimensional ultrasound imaging apparatus, a photoacoustic tomography apparatus, a Position Emission Tomography/Single Photon Emission Computed Tomography (PET/SPECT), an Optical Coherence Tomography (OCT) apparatus, or the like. Further, the first medical image and the second medical image may be any image as long as they are three-dimensional tomographic images for which a subtraction image is to be generated. For example, it may be possible to adopt images that are obtained by capturing the same patient at different dates and times for a follow-up. Furthermore, it may be possible to adopt images that are captured at different contrast phases in a single examination.

For example, the first medical image and the second medical image are three-dimensional medical images (three-dimensional tomographic images) that are configured as a set of two-dimensional tomographic images. Further, it is assumed that a position and a posture of each of the two-dimensional tomographic images are converted to a reference coordinate system (a spatial coordinate system with reference to a subject) and stored in the data server 130. In this case, the first medical image and the second medical image that are represented by the reference coordinate system are input to the image processing apparatus 100 in accordance with an instruction that is given by a user who operates an instruction unit 140. The instruction unit 140 includes various kinds of input devices that receive various kinds of commands from the user. For example, the instruction unit 140 may be a mouse, a keyboard, a trackball, a touch panel, or the like, and includes various kinds of devices that allow the user to input various kinds of information or processing requests.

The image processing apparatus 100 is an apparatus that receives a processing request from the instruction unit 140 and performs image processing. Specifically, the image processing apparatus 100 receives, as a pair of images (image pair) to be subjected to image processing, the first medical image and the second medical image that are image processing targets, from the data server 130 based on an instruction that is given by the user through the instruction unit 140. Further, the image processing apparatus 100 generates a subtraction image between the acquired first medical image and the acquired second medical image, and stores or displays, on the display unit 150, the generated subtraction image.

The image processing apparatus 100 includes components as described below. The components described below are implemented by causing processing circuitry that is included in the image processing apparatus 100 to execute a code that is included in a program. For example, the components described below implement functions of each of units by causing one or more Central Processing Units (CPUs) that function as control units of the image processing apparatus 100 to execute a program. The components of the image processing apparatus 100 may be implemented on integrated circuitry as long as the same functions are implemented.

For example, the image processing apparatus 100 includes a storage unit (not illustrated) and processing functions corresponding to an image acquisition unit 101, an identification information acquisition unit 102, a registration information acquisition unit 103, a subtraction image generation unit 104, and a display control unit 105 are stored in the storage unit in the form of a computer-executable program. The processing circuitry that is included in the image processing apparatus 100 is a processor that implements a function corresponding to each of programs by reading the programs from the storage unit and executing the programs. In other words, the processing circuitry in a state in which a program is read has a function corresponding to the read program. The image acquisition unit 101, the identification information acquisition unit 102, the registration information acquisition unit 103, the subtraction image generation unit 104, and the display control unit 105 may be implemented by being appropriately distributed to a plurality of processing circuitry or integrated into single processing circuitry.

The image acquisition unit 101 acquires information on the first medical image and the second medical image that are to be input to the image processing apparatus 100. The identification information acquisition unit 102 acquires identification information on a part that is drawn in the input medical images. The registration information acquisition unit 103 acquires registration information that represents coordinate correspondence between the first medical image and the second medical image. The subtraction image generation unit 104 generates a subtraction image between the first medical image and the second medical image based on the registration information. The display control unit 105 performs display control of causing the display unit 150 to display the generated subtraction image. The image acquisition unit 101 is an example of an image acquisition means. The identification information acquisition unit 102 is an example of an identification information acquisition means. The subtraction image generation unit 104 is an example of a subtraction image generation means. The display control unit 105 is an example of a display control means.

The display unit 150 includes an arbitrary device, such as a Liquid Crystal Display (LCD), a Cathode Ray Tube (CRT), a plasma display, or an organic electroluminescence (EL) panel, and displays a medical image or the like.

Specifically, the display unit 150 displays cross-sectional images of the first medical image and the second medical image that are acquired from the image processing apparatus 100. Further, the display unit 150 displays a cross-sectional image or a projected image of the subtraction image that is generated by the image processing apparatus 100. Flow of process performed by image processing apparatus 100

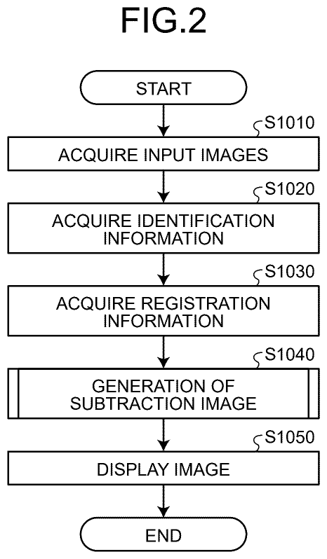

FIG. 2 is a flowchart illustrating the flow of an entire process performed by the image processing apparatus 100. S1010: Acquisition of input image

At Step S1010, the image acquisition unit 101 acquires, from the data server 130, the first medical image and the second medical image that are designated by the user through the instruction unit 140. Further, the image acquisition unit 101 outputs the first medical image and the second medical image to each of the identification information acquisition unit 102, the registration information acquisition unit 103, the subtraction image generation unit 104, and the display control unit 105.

Meanwhile, the images need not always be acquired based on an instruction that is given by the user, but may be acquired by any different method. For example, it is possible to automatically determine whether or not to adopt a new image as the first medical image (whether or not the image is a target for which a subtraction image is to be generated) based on a predetermined rule every time the new image is registered in the data server 130. The determination is performed based on, for example, a type of modality or an imaging range. For example, when a CT apparatus captures an image of a thoracoabdominal part, the image may be adopted as the first medical image. In this case, it is possible to automatically acquire the second medical image from among past images that are stored in the data server 130. For example, it may be possible to adopt, as the second medical image, an image that is obtained in a previous examination with respect to the same patient as the first medical image. Further, the user may designate the first medical image, and the second medical image may be automatically acquired by the method as described above. S1020: Acquisition of identification information

At Step S1020, the identification information acquisition unit 102 acquires identification information on a part that is drawn in the first medical image. Further, the acquired identification information is output to the subtraction image generation unit 104.

The identification information acquisition unit 102 acquires, as the identification information on a part, identification information on a part at a plurality of coordinates in the first image. For example, the identification information acquisition unit 102 acquires information that indicates a part (organ) to which each of pixels of the first medical image belongs. The identification information on a part is represented, for example, in the form of a label image that includes, as a pixel value, a value of a label that identifies the part. The label image may be an image that has the same resolution (pixel size) as the first medical image and that has one-to-one correspondence with each of the pixels of the first medical image (indicating the part to which each of the pixels of the first medical image belong), or may be an image with different resolution (pixel size) from the first medical image. In the following, it is assumed that the identification information on the part is a label image that has the same resolution as the first medical image.

Meanwhile, it is possible to appropriately perform various kinds of processing on the first medical image. For example, it may be possible to perform a well-known adjustment process, such as a deformation process, a rotation process, a registration process, a resolution conversion process, a tone adjustment process, a masking process, a trimming process, or an angle-of-view increase process, on the first medical image. Further, it may be possible to convert a data format of the first medical image or add additional information to the first medical image. The term “first medical image” is not limited by presence or absence of the process as described above. Specifically, even when a certain process is performed on the first medical image, if the image that is subjected to the process indicates substantially the same information as the image that is not subjected to the process, the image subjected to the process is the first medical image. If external processing, such as a subtraction process or a composition process with respect to a different image, is performed on the first medical image, the image that is subjected to the process does not, of course, indicate substantially the same information as the first medical image. In this case, for example, the image will be referred to as a different description, such as a subtraction image or a composite image. The same applies to the second medical image.

In the present embodiment, the identification information acquisition unit 102 acquires identification information for identifying each of a “spinal canal” that is a first part drawn in the first medical image and a “bone” that is a second part drawn in the first medical image. Specifically, a label image in which a label value that represents the “spinal canal” is added to a pixel that is identified as drawing the spinal canal and a label value that represents the “bone” is added to a pixel that is identified as drawing the bone is acquired. Meanwhile, as for the label for the bone, all of bones may be represented as the same part (that is, by the same level value), or the bone may be distinguished in detail (for example, a skull, a vertebra, a rib, a collarbone, a breastbone, a pelvis, a thighbone, and the like) and each of the bones may be represented by a different label value. Further, it may be possible to adopt a label image in which a part other than the “bone” and the “spinal canal” is also identified. The other part includes an organ and soft tissue.

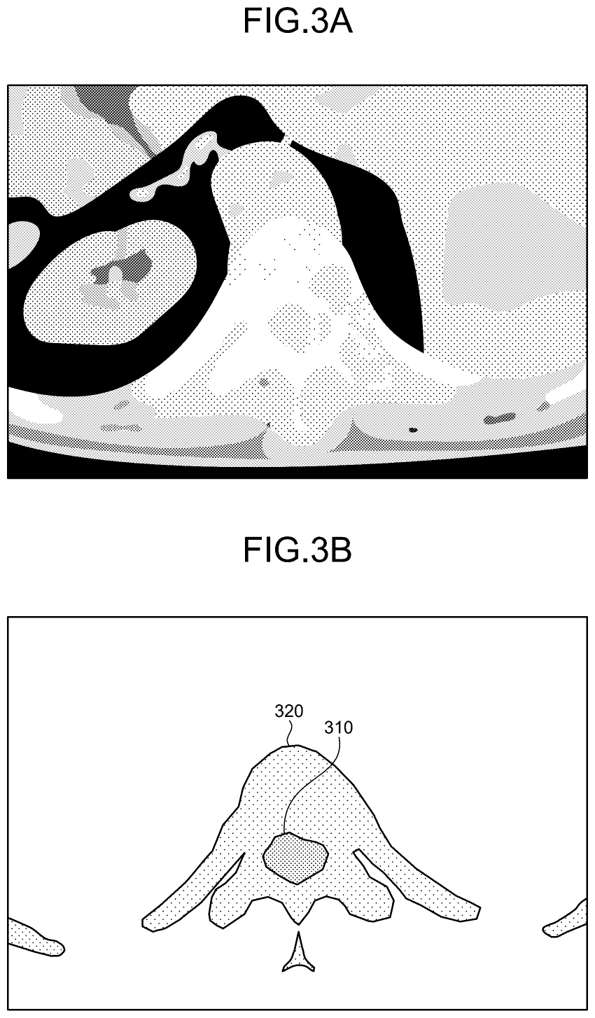

The identification information on the part that is acquired by the identification information acquisition unit 102 will be described below with reference to FIG. 3A and FIG. 3B. FIG. 3A illustrates a two-dimensional cross-sectional image in which one cross section of the first medical image is cut out. This example illustrates a diagram in which a vertebra and surroundings of the vertebra are enlarged and cut out from a cross-sectional image that illustrates an axial plane, and the vertebra and surrounding organs are drawn. In contrast, FIG. 3B illustrates identification information that corresponds to the cross-sectional image. In FIG. 3B, 310 denotes a region that is identified as the spinal canal, and 320 denotes a region that is identified as the bone.

Here, the part (organ) in the image is identified by using a well-known technology. The identification information acquisition unit 102 according to the present embodiment identifies each of parts by a region extraction method using well-known machine learning. For this, an inference model (segmentation model) that is trained by pairs of CT images of a large number of cases and corresponding label images as training data is established in advance. The identification information acquisition unit 102 inputs the first medical image that is a processing target to the inference model, and extracts a label region of each of the parts (generates a label image). Examples of the region extraction method using well-known machine learning include U-net based on a Convolutional Neural Network (CNN) and a developed method. Meanwhile, it may be possible to use a different well-known technology, rather than U-Net, for the region extraction method. For example, a method based on a Generative Adversarial Network (GAN), a method based on Vision Transformer, and the like are known, and any of the methods is applicable. In this case, it may be possible to use an inference model that is generated for each of the parts, or it may be possible to use an inference model that simultaneously identifies a plurality of parts. Further, it may be possible to integrate and use identification results of a plurality of inference models that identify the same part. Furthermore, it may be possible to extract a region by a method other than the machine learning, such as a method of adopting a statistical geometric model of an organ to a medical image. Moreover, it may be possible to extract a region by a rule-based image processing method as described in Patent Literature 2, or it may be possible to use any of other region extraction methods.

Furthermore, the identification information may be acquired by any of other methods. For example, the identification information acquisition unit 102 may read and acquire identification information (label image) that is stored in advance in the data server 130 in association with the first medical image, instead of performing an identification process. Alternatively, it may be possible to perform a process of acquiring identification information on a part on the second medical image, and acquire desired identification information by converting the acquired identification information to a space of the first medical image by using registration information (to be described later). Moreover, it may be possible to acquire the identification information by integrating the identification information that is acquired from the second medical image as described above and the identification information that is acquired from the first medical image. For example, a pixel that is identified as a “bone” by at least one of the two pieces of identification information may be identified as the “bone”. With this configuration, even when it is difficult to identify a part in one of the images (for example, the first medical image) due to disease progresses or the like, it is possible to obtain correct identification information if the part can be identified in the other image (for example, the second medical image). For example, if osteolytic bone metastasis progresses, it may be difficult to identify a corresponding part as a bone in the first medical image; however, if it is possible to recognize the corresponding part as the bone in the second medical image, it may be possible to identify the corresponding part as the bone.

S1030: Acquisition of registration information

At Step S1030, the registration information acquisition unit 103 acquires registration information that represents coordinate correspondence between the first medical image and the second medical image. Further, the acquired registration information is output to the subtraction image generation unit 104.

The registration information acquisition unit 103 according to the present embodiment performs deformed registration between the first medical image and the second medical image by using a well-known inter-image registration method, and acquires the registration information in the form of a displacement field between the images. As the deformed registration, it is possible to use a well-known method, such as the Demons algorithm, Large Deformation Diffeomorphic Metric Mapping (LDDMM), a registration method based on deep learning, or the like.

Furthermore, the registration information may be acquired by any of other methods. For example, the registration information acquisition unit 103 may read and acquire the registration information (displacement field) that is stored in advance in the data server 130 in association with the pair of the first medical image and the second medical image, instead of performing a registration process.

S1040: Generation of subtraction image

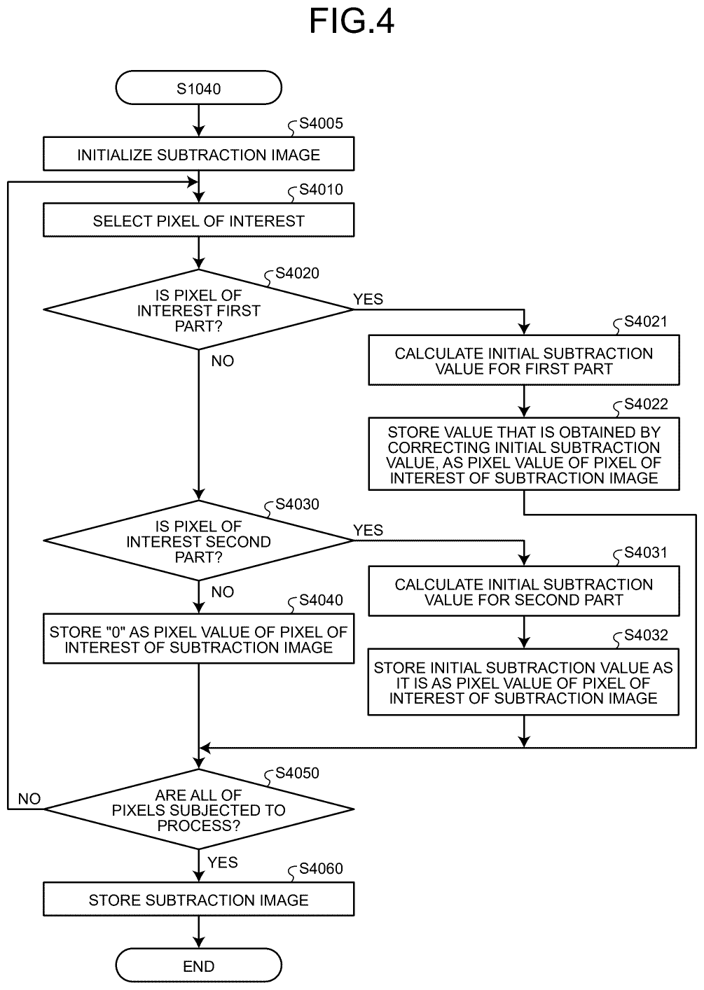

At Step S1040, the subtraction image generation unit 104 generates a subtraction image between the first medical image and the second medical image. Further, the generated subtraction image is output to the display control unit 105. FIG. 4 is a flow diagram illustrating the flow of a process that is performed by the subtraction image generation unit 104 at Step S1040.

S4005: Initialization of subtraction image

At Step S4005, the subtraction image generation unit 104 initializes a subtraction image that is to be generated. Specifically, a memory region for the subtraction image to be generated is ensured, and a pixel value of “0” is added to all of pixels.

Here, it is preferable to set, as an image range of the subtraction image, the same range as an image range of the first medical image. Alternatively, it may be possible to adopt, as the image range of the subtraction image, a rectangular region or the like that is separately designated by the user. Further, the subtraction image may have the same resolution as or different resolution from the first medical image.

S4010: Selection of pixel of interest

At Step S4010, the subtraction image generation unit 104 selects, as a pixel of interest, a pixel for which a subtraction value is not yet set from among pixels on the subtraction image. For example, the pixel of interest is sequentially determined by raster scan. Further, the subtraction image generation unit 104 determines a coordinate (first coordinate) on the first medical image corresponding to the selected pixel of interest, based on correspondence between the subtraction image and the first medical image. Furthermore, the subtraction image generation unit 104 determines a coordinate (second coordinate) on the second medical image corresponding to the first coordinate, based on the registration information (displacement field) that is acquired at Step S1030.

Meanwhile, the pixel of interest may be each of the pixels on the subtraction image, or may be each of pixels in a region of interest on a subtraction image (or on the first medical image) that is separately designated. For example, it may be possible to set, as the region of interest, a range in which the image range of the first medical image and the image range of the second medical image overlap with each other (range in which the subtraction value can be calculated). Alternatively, it may be possible to adopt, as the region of interest, an inside of a body of a patient on the first medical image, or it may be possible to adopt, as the region of interest, a rectangular region or the like that is separately designated by the user.

S4020: Determination on first part

At Step S4020, the subtraction image generation unit 104 refers to the identification information that is acquired at Step S1020, and determines whether or not the pixel of interest is identified as belonging to the first part. More specifically, the determination is performed based on whether or not a pixel value (label value) of a label image that corresponds to the pixel of interest indicates the first part. The first part in the present embodiment is the spinal canal, and therefore, when the pixel value (label value) of the label image that corresponds to the pixel of interest indicates the spinal canal, it is determined that “the pixel of interest belongs to the first part”. Further, when it is determined that “the pixel of interest belongs to the first part”, the process goes to Step S4021, and a process of calculating a subtraction value that is suitable for the first part is performed. In contrast, when it is determined that “the pixel of interest does not belong to the first part”, the process goes to Step S4030.

S4021: Calculation of initial subtraction value

At Step S4021, the subtraction image generation unit 104 calculates an initial subtraction value in the case where the pixel of interest is identified as belonging to the first part (in the present embodiment, the spinal canal). In the present embodiment, a simple subtraction value that is obtained by simply subtracting a pixel value at the second coordinate on the second medical image from a pixel value at the first coordinate on the first medical image is adopted as the initial subtraction value. This is because a property change between the CT images, which needs to be paid attention to in the spinal canal, is small as a pixel value, and it is needed to avoid loss of signal due to a noise reduction process or the like.

Meanwhile, the pixel value at the first coordinate on the first medical image is a pixel value of a pixel that is located at the first coordinate among the pixels that are included in the first medical image. Alternatively, the pixel value at the first coordinate on the first medical image is a statistical value (an average value, a median value, or the like) based on a plurality of pixels that are included in a predetermined range from the first coordinate among the pixels that are included in the first medical image. The same applies to the pixel value at the second coordinate on the second medical image.

Furthermore, in one embodiment, explanation will be given based on the assumption that the pixel values of the first medical image and the second medical image increase with an increase in CT values. In this case, a region with a higher density, such as a bone, has a larger pixel value than a region with a lower density, for example. It is of course possible to arbitrarily modify the way to define the pixel value of each of the images, and it is possible to perform setting such that the pixel value in the region with a higher density is decreased. Even in this case, for example, by reversing inequality signs in Expression (1) (to be described later), each of the embodiments is applicable in the same manner.

S4022: Correction and storage of subtraction value

At Step S4022, the subtraction image generation unit 104 corrects the initial subtraction value in the case where the pixel of interest is identified as belonging to the first part (in the present embodiment, the spinal canal). Further, the subtraction image generation unit 104 records the subtraction value that is corrected (corrected subtraction value), as the pixel value of the pixel of interest, in the subtraction image. Then, the process goes to Step S4050.

More specifically, the subtraction image generation unit 104 determines whether or not the initial subtraction value meets a predetermined condition, and determines, as the pixel value of the pixel of interest, a corrected subtraction value that is obtained by performing a predetermined correction process corresponding to a determination result on the initial subtraction value. As one example, the subtraction image generation unit 104 determines polarity (positive or negative) of the initial subtraction value, and changes (corrects) the subtraction value to “0” when the polarity is certain polarity that is determined in advance (in the present embodiment, negative). That is, the subtraction image generation unit 104 determines the corrected subtraction value by Expression (1).

$${x}^{′} = \{ \begin{matrix}0 , & x < 0 \\ x , & x \geq 0\end{matrix} \qquad ( 1 )$$

Here, x represents the initial subtraction value and x′ represents the corrected subtraction value. Specifically, “the polarity of the initial subtraction value is positive or negative” is one example of the predetermined condition, and Expression (1) is one example of the predetermined correction process corresponding to the determination result.

Meanwhile, as indicated by Expression (1), it is preferable to set the corrected value to “0”, but it is possible to approximately achieve the same effect even when the corrected value is set to a value close to “0” (as one example, “−1”, “1”, or the like).

Meanwhile, the predetermined correction process corresponding to the determination result may be other than as described above. For example, when the initial subtraction value meets the predetermined condition, the subtraction image generation unit 104 may perform correction of attenuating the subtraction value by multiplying the initial subtraction value by a predetermined coefficient. Specifically, the subtraction image generation unit 104 determines the corrected subtraction value by Expression (2).

$${x}^{′} = \{ \begin{matrix}ax , & x < 0 \\ x , & x \geq 0\end{matrix} \qquad ( 2 )$$

Here, a represents a positive coefficient and has a value that is equal to or larger than “0” and smaller than “1”. For example, it is possible to set a value of “0.05”, “0.1”, “0.2”, or the like.

Furthermore, as the predetermined correction process corresponding to the determination result, it may be possible to use a process of emphasizing a subtraction value (in the present embodiment, a positive subtraction value) other than the subtraction value that is to be reduced, instead of the process of reducing the subtraction value (in the present embodiment, a negative subtraction value) as represented by Expression (2). For example, the subtraction image generation unit 104 may determine the corrected subtraction value by Expression (3).

$${x}^{′} = \{ \begin{matrix}x , & x < 0 \\ bx , & x \geq 0\end{matrix} \qquad ( 3 )$$

Here, b represents a positive coefficient and has a value that is larger than “1”. For example, it is possible to set a value of “1.2”, “1.5”, “2.0”, or the like.

Furthermore, the predetermined condition is not limited to a condition that “the polarity of the initial subtraction value is positive or negative”. For example, the predetermined condition may be a condition that “the initial subtraction value is smaller than a first threshold around zero or not”. In this case, the subtraction image generation unit 104 determines the corrected subtraction value by Expressions (4) to (6), instead of Expressions (1) to (3).

$${x}^{′} = \{ \begin{matrix}t , & x < t \\ x , & x \geq t\end{matrix} \qquad ( 4 )$$

$${x}^{′} = \{ \begin{matrix}ax + ( 1 - a ) t , & x < t \\ x , & x \geq t\end{matrix} \qquad ( 5 )$$

$${x}^{′} = \{ \begin{matrix}x , & x < t \\ bx + ( 1 − b ) t , & x \geq t\end{matrix} \qquad ( 6 )$$

Here, t represents the first threshold and preferably has a value around “0” (as one example, “−1”, “1”, or the like). Meanwhile, in Expressions (4) to (6), the correction process is performed when the initial subtraction value is smaller than the first threshold, but it may be possible to perform the correction process when the initial subtraction value is equal to or smaller than the first threshold.

When a disease (as a main case, infiltration of cancer tumor into the spinal canal) occurs in the spinal canal, an increase in a pixel value appears in the CT image, and the disease tends to be drawn as a positive subtraction value in the subtraction image. In contrast, a negative subtraction value is likely to represent an error in registration, an artifact in the CT image, or a normal property change that is not focused on by a doctor, and therefore, by removing or attenuating a corresponding signal from the subtraction image, it is possible to emphasize a change that is useful for diagnosis.

As described above, the subtraction image generation unit 104 determines the initial subtraction value by Expressions (1) to (3) when the threshold is set to “0”, and determines the initial subtraction value by Expressions (4) to (6) when the first threshold that has a value that is not strictly “0” but is close to “0” is used. Here, the first threshold may be a value that is obtained by simply approximating “0”, or may be a value that is adjusted depending on purposes.

For example, when a value larger than “0” is used as the first threshold, a corresponding signal is removed or attenuated from the subtraction image not only when the pixel value decreases, but also when the pixel value slightly increases. A slight increase in the pixel value may occur simply due to a measurement error, and therefore, by removing or attenuating the corresponding signal from the subtraction image, it is possible to further emphasize a change that is useful for diagnosis and improve visibility of the subtraction image. In contrast, in a case where a value smaller than “0” is used as the first threshold, even when the pixel value decreases, if the decrease in the pixel value is a slight change, the corresponding signal is not removed or attenuated from the subtraction image, so that it is possible to prevent overlooking of a disease. The first threshold may be set by taking into account a balance between the visibility of the subtraction image and prevention of overlooking of a disease as described above. Furthermore, it may be possible to allow the user to arbitrarily adjust the first threshold.

S4030: Determination of second part

At Step S4030, the subtraction image generation unit 104 determines whether or not the pixel of interest is identified as belonging to the second part (in the present embodiment, the bone), through the same process as the process at Step S4020. Further, when it is determined that “the pixel of interest belongs to the second part”, the process goes to Step S4031, and a process of calculating a subtraction value that is suitable for the second part is performed. In contrast, “when it is determined that “the pixel of interest does not belong to the second part”, the process goes to Step S4040.

S4031: Calculation of initial subtraction value

At Step S4031, the subtraction image generation unit 104 calculates the initial subtraction value in the case where the pixel of interest is identified as belonging to the second part (in the present embodiment, the bone). In the present embodiment, with use of the voxel matching method described in Patent Literature 3, a subtraction value between the first coordinate on the first medical image and the second coordinate on the second medical image (more accurately, between a neighborhood region of the first coordinate and a neighborhood region of the second coordinate) is calculated, and the subtraction value is adopted as the initial subtraction value. With this configuration, it is possible to reduce noise that is caused by the partial volume effect that occurs when a slice of the CT image is thick.

S4032: Storage of subtraction value

At Step S4032, the subtraction image generation unit 104 records the initial subtraction value as calculated at Step S4031 in the subtraction image, as the pixel value of the pixel of interest in the case where the pixel of interest is identified as belonging to the second part (in the present embodiment, the bone). Then, the process goes to Step S4050. S4040: Storage of subtraction value

At Step S4040, the subtraction image generation unit 104 records the subtraction value of “0” in the subtraction image, as the pixel value of the pixel of interest in the case where the pixel of interest is identified as not belonging to the first part and the second part. Then, the process goes to Step S4050.

S4050: Determination of termination

At Step S4050, the subtraction image generation unit 104 determines whether or not a pixel for which a subtraction value is not set remains. When it is determined that the pixel for which the subtraction value is not set remains, the process goes to Step S4010, and a process of setting a pixel value of a new pixel of interest is performed again. In contrast, when it is determined that the process on all of the pixels is terminated, the process goes to Step S4060. S4060: Storage of subtraction image

At Step S4060, the subtraction image generation unit 104 stores the generated subtraction image in a storage unit (not illustrated). By storing the generated subtraction image in the storage unit, the subtraction image generation unit 104 is able to easily acquire the subtraction image by reading the subtraction image from the storage unit when it is needed to acquire the subtraction image of the same input image again after the process by the image processing apparatus 100 is terminated. Meanwhile, the step of storing the subtraction image in the storage unit need not always be performed.

Thus, the process at Step S1040 is performed.

S1050: Display

At Step S1050, the display control unit 105 causes the display unit 150 to display the subtraction image or the like that is generated by the subtraction image generation unit 104. The display unit 150 includes a GUI for acquiring an instruction from a user, such as a doctor. The user is able to display a cross-sectional image or a projection image of each of the first medical image, the second medical image, and the subtraction image while freely switching one to another or arranging images side by side.

Thus, the process by the image processing apparatus 100 is performed.

Conventionally, in the medical field, attempts are being made to generate a subtraction image between images that are obtained by performing imaging at different times by various kinds of modality and visualize a temporal change of a lesion or the like. For example, Patent Literature 1 discloses a technology for performing registration between two CT images and generating a subtraction image that is suitable for observation of a bone. Furthermore, Patent Literature 2 discloses a technology for recognizing a bone or a spinal canal in a CT image, calculating a subtraction value by a method that is suitable for each observation, and generating a subtraction image. However, in the technologies disclosed in Patent Literature 1 and Patent Literature 2, in some cases, unneeded information that is included in the subtraction image may impede determination that is to be made by an observer. In contrast, according to the present embodiment by performing a process of calculating and correcting a subtraction value in accordance with a part, it is possible to eliminate unneeded information that is included in the subtraction image.

### First Modification

The subtraction image generation unit 104 may further extract a region of interest based on the initial subtraction value or the corrected subtraction value. For example, the subtraction image generation unit 104 determines whether or not the initial subtraction value of a pixel that is identified as the first part is equal to or smaller than “0” or the first threshold around “0” as represented by Expressions (1) to (6), and acquires the corrected subtraction value by performing the correction process corresponding to the determination result on the initial subtraction value. Accordingly, in the subtraction image, a negative subtraction value that is likely to represent other than a disease is removed or attenuated, and a positive subtraction value is emphasized. In this case, the subtraction image generation unit 104 may further extract a region of interest that is highly likely to represent a disease from a region that has a positive subtraction value.

For example, the subtraction image generation unit 104 extracts a region of interest by performing, with the second threshold, a threshold process on the initial subtraction value or the corrected subtraction value with respect to a plurality of pixels identified as the first part in the subtraction image. Specifically, when the corrected subtraction value is acquired by Expression (1), Expression (2), Expression (4), or Expression (5), the subtraction image generation unit 104 performs a threshold process on the initial subtraction value by using the second threshold and extracts a region of interest. Furthermore, when the corrected subtraction value is acquired by Expression (3) or Expression (6), the subtraction image generation unit 104 performs a threshold process on the corrected subtraction value by using the second threshold and extracts a region of interest. A numerical value of the second threshold is not specifically limited, but is preferably larger than the first threshold as described above. Moreover, it may be possible to allow the user to arbitrarily adjust the second threshold. Thus, according to the subtraction image generation unit 104 of the first modification, a negative subtraction value is removed or attenuated, and a region that is highly likely to represent a disease among positive subtraction values is extracted as a region of interest. Specifically, by using two criteria, the subtraction image generation unit 104 is able to eliminate unneeded information that is included in the subtraction image and give order of priority to needed information, so that it is possible to realize more effective image diagnosis.

### Second Modification

In the present embodiment, in the process at Step S4040, the subtraction image generation unit 104 sets a subtraction value of a pixel of interest that is identified as a region (background region) other than the first part and the second part to “0”. However, it may be possible to set a subtraction value of a pixel of interest that is identified as the background region. With this configuration, a subtraction value is not completely removed when accuracy of a process of identifying a part is inadequate and a certain part is overlooked (specifically, when a pixel of interest in a first region or a second region is erroneously identified as a background region), so that it is possible to reduce a risk of overlooking of a change. In this case, it is possible to use, as a method of calculating the subtraction value, a method described in Patent Literature 1, for example. Meanwhile, even in this case, it may be possible to set a subtraction value of a pixel of interest that is identified as being outside of the body to “0”.

### Third Modification

In the present embodiment, the spinal canal is adopted as the first part. However, it may be possible to adopt any part other than the spinal canal as long as the part mainly includes a disease that is drawn with an increased pixel value in an image.

For example, it may be possible to adopt a region in the vicinity of the vertebra (vertebra peripheral region) as the first part. The vertebra peripheral region is, for example, soft tissue adjacent to the vertebra. Alternatively, it may be possible to adopt both of the spinal canal and the vertebra peripheral region as the first part. In the vicinity of the vertebra, in some cases, extraosseous invasion of bone metastasis of cancer may occur. The extraosseous invasion is drawn with an increased pixel value in a CT image, and the disease tends to be drawn with a positive subtraction value in a subtraction image; therefore, removal or attenuation of a negative subtraction value is effective.

In this case, in the process at Step S1030, by separately recognizing the vertebra from the bone that is the second part, the identification information acquisition unit 102 is able to identify a region in the vicinity of the vertebra (for example, a region within a range at a predetermined distance from an outer edge of the vertebra) as the “vertebra peripheral region”. In this case, it may be possible to prevent the vertebra peripheral region from protruding from a body region by setting the predetermined distance as described above to a relatively small distance on the dorsal side of the vertebra as compared to the ventral side.

Meanwhile, when the vertebra peripheral region is adopted as the first part, in the process at Step S4022, the subtraction image generation unit 104 may set, as the pixel value of the subtraction image, a new corrected subtraction value x″ that is obtained by further performing a correction process corresponding to a distance from the outer edge of the vertebra, instead of adopting the calculated corrected subtraction value x′ as it is as the pixel value of the subtraction image. Specifically, it may be possible to store, as the pixel value of the subtraction image (the corrected subtraction value x″), a value that is obtained by compositing, at a composition ratio that has “1” at the outer edge of the vertebra and that is gradually reduced with an increase in the distance from the outer edge of the vertebra, the corrected subtraction value x′ of the pixel of interest and a subtraction value x_bg (hereinafter, a subtraction value of the background region) based on the assumption that the pixel of interest represents the background region. In other words, the corrected subtraction value x″ is determined by Expression (7).

$${x}^{″} = {wx}^{′} + ( 1 - w ) x\_bg \qquad ( 7 )$$

Here, w represents the composition ratio as described above. In this case, by performing adjustment such that the composition ratio is “0” at a boundary between the vertebra peripheral region and the background region located outside the vertebra peripheral region, it is possible to maintain continuity of the subtraction value in the vicinity of the boundary. Here, the subtraction value x_bg of the background region may be calculated by, for example, the method described in Patent Literature 1, similarly to the second modification.

As a specific example, for example, when the corrected subtraction value x′ is defined by Expression (1) (that is, when a correction method of correcting the corrected subtraction value to “1” when the initial subtraction value is negative is used), the new corrected subtraction value x″ is set by Expression (8) that is obtained by assigning Expression (1) to Expression (7).

$${x}^{″} = \{ \begin{matrix}( 1 - w ) x\_bg , & x < 0 \\ wx + ( 1 + w ) x\_bg , & x \geq 0\end{matrix} \qquad ( 8 )$$

In other words, when x is a positive value (when the predetermined condition is not met as in the lower part of Expression (8)), a value that is obtained by gradually replacing the initial subtraction value x with the background subtraction value x_bg in accordance with the distance from the outer edge of the vertebra is stored as the corrected subtraction value x″. In contrast, when x is a negative value (when the predetermined condition is met as in the upper part of Expression (8)), a value that is obtained by gradually replacing the value of zero with the background subtraction value x_bg in accordance with the distance from the outer edge of the vertebra is stored as the corrected subtraction value x″. In other words, the initial subtraction value is corrected to zero at the outer edge of the vertebra. Further, the degree of correction is attenuated (the composition ratio of the background subtraction value x_bg is increased) with an increase in the distance from the outer edge of the vertebra, and the background subtraction value x_bg is adopted as it is at the boundary between the vertebra peripheral region and the background region.

Here, when the subtraction value x_bg of the background region is set to “0” (that is, when the process described at Step S4040 in the first embodiment is performed), the process is equivalent to a process of setting, in the subtraction image, a value that is obtained by performing, on the corrected subtraction value x′, an attenuation process of performing adjustment such that a degree of attenuation is increased with an increase in the distance from the outer edge of the vertebra. Specifically, Expression (7) and Expression (8) are simplified as Expression (9) and Expression (10).

$${x}^{″} = {wx}^{′} \qquad ( 9 )$$

$${x}^{″} = \{ \begin{matrix}0 , & x < 0 \\ wx , & x \geq 0\end{matrix} \qquad ( 10 )$$

More specifically, when x is a positive value (when the predetermined condition is not met as in the lower part of Expression (10)), a value that is obtained by gradually attenuating the initial subtraction value x in accordance with the distance from the distance from the outer edge of the vertebra is stored as the corrected subtraction value x″. In contrast, when x is a negative value (when the predetermined condition is met as in the upper part of Expression (10)), the value of “0” is stored as the corrected subtraction value x″ independently of the distance from the outer edge of the vertebra. With this configuration, the corrected subtraction value x″ approaches “0” with an increase in the distance from the outer edge of the vertebra, so that it is possible to obtain a subtraction image in which a boundary with the background region is smooth.

In contrast, when the initial subtraction value x that is obtained by the same calculation method as the first part is given (that is, when x_bg=x) as the subtraction value x bg of the background region, Expression (8) is simplified as Expression (11).

$${x}^{″} = \{ \begin{matrix}( 1 - w ) x , & x < 0 \\ x , & x \geq 0\end{matrix} \qquad ( 11 )$$

This is equivalent to a case in which the process of correcting x to x′ is gradually attenuated with an increase in the distance from the outer edge of the vertebra. In other words, when x is a positive value (when the predetermined condition is not met as in the lower part of Expression (11)), the initial subtraction value x is always stored as it is as the corrected subtraction value x″ independently of the distance from the outer edge of the vertebra. In contrast, when x is a negative value (when the predetermined condition is met as in the upper part of Expression (11)), a value that is obtained by performing the correction process in accordance with the distance from the outer edge of the vertebra is stored as the corrected subtraction value x″. In other words, the subtraction value is corrected to “0” at the outer edge of the vertebra. Further, the degree of correction is attenuated with an increase in the distance from the outer edge of the vertebra, and the initial subtraction value x is adopted as it is at the boundary between the vertebra peripheral region and the background region.

As described above, by maintaining continuity of the subtraction value while moderately changing a correction amount of the subtraction value from a reference position, such as the outer edge of the vertebra, with respect to a region that is not anatomically clearly defined unlike the vertebra peripheral region, it is possible to prevent drawing of unnatural subtraction value.

Furthermore, when the first part includes a plurality of parts, the subtraction image generation unit 104 may change the initial subtraction value correction method for each of the parts at Step S4022. More specifically, when the first part includes both of the spinal canal and the vertebra peripheral region, the subtraction image generation unit 104 corrects the negative subtraction value to “0” with respect to the corrected subtraction value of the spinal canal. In contrast, in the vertebra peripheral region, adjustment is performed such that a degree of attenuation of the corrected subtraction value is gradually increased in accordance with the distance from the outer edge of the vertebra. In this manner, by changing the initial subtraction value correction method in accordance with the part, it is possible to draw the subtraction value that is appropriately corrected in accordance with the part.

### Fourth Modification

In the present embodiment, a part (organ) that mainly includes a disease that is drawn with an increased pixel value in an image is adopted as the first part, and a subtraction image is generated by removing or attenuating a negative subtraction value only with respect to the part. In contrast, it may be possible to adopt, as the first part, a part (organ) that mainly includes a disease that is drawn with a decreased pixel value in an image, and generate a subtraction image by removing or attenuating a positive subtraction value only with respect to the part. For example, it may be possible to generate a temporal subtraction image by using the process on a tumor that is drawn in an ultrasound image of a mammary gland. A mammary tumor in the ultrasound image is mainly drawn as a darker region as compared to normal tissue, and therefore, by removing or attenuating the positive subtraction value, it is possible to emphasize a region of interest in the temporal subtraction image. Meanwhile, it may be possible to adopt a configuration in which a region in which a negative subtraction value is removed or attenuated and a region in which a positive subtraction value is removed or attenuated (and a region in which a difference is not removed or attenuated) are simultaneously present.

### Fifth Modification

In the present embodiment, in the process at Step S1040, the subtraction image generation unit 104 calculates the initial subtraction value by using a different process for each of the first part and the second part, but it may be possible to calculate the initial subtraction value by using a common process that does not depend on a part. For example, it may be possible to adopt a simple subtraction as the initial subtraction value in any of parts. In this case, at Step S4031, the subtraction image generation unit 104 performs the same process as the process at Step S4021. In this case, the subtraction image generation unit 104 may generate an initial subtraction image that includes the initial subtraction value immediately after Step S4005, and acquire the initial subtraction value from the initial subtraction image in the process at Step S4022 or Step S4032. Meanwhile, the initial subtraction value may be obtained by a different method, and, for example, it may be possible to calculate the initial subtraction value by using the voxel matching method in any of parts. Meanwhile, the method of calculating the initial subtraction value is not limited to the simple different and the voxel matching method described in the examples, and it may be possible to any of well-known subtraction value calculation methods.

### Sixth Modification

In the present embodiment, the display control unit 105 causes the display unit 150 to display the generated subtraction image at Step S1050. However, the process of displaying the subtraction image is not always needed. It may be possible to output the subtraction image to outside (for example, the data server 130) in association with the first medical image, instead of displaying the subtraction image. Furthermore, it may be possible to further provide an image recognition unit (not illustrated) and perform an image recognition process using the generated subtraction image as input. For example, it may be possible to input the subtraction image to an inference model (not illustrated), and display or store a result.

### Seventh Modification

In the present embodiment, in the process at Step S1040, the subtraction image generation unit 104 generates a subtraction image (integrated subtraction image) in which subtraction values in a plurality of parts, such as the first part and the second part, are integrated and represented in a single image. However, it may be possible to generate a subtraction image for each of parts, instead of generating the integrated subtraction image. For example, it may be possible to separately generate a first subtraction image in which only a subtraction value related to the first part is stored, and a second subtraction image in which only a subtraction value related to the second part is stored. In this case, in the process at Step S1050, the display control unit 105 may display the two subtraction images side by side, or display the subtraction images while switching from one to the other in accordance with an instruction that is given by the user. Furthermore, at the time of display, it may be possible to display the two subtraction images in an integrated manner. Moreover, it may be possible to generate both of the integrated subtraction image and the subtraction image of each of the parts.

Furthermore, in the process at Step S1040, the subtraction image generation unit 104 may further generate the initial subtraction image that is an image made of the initial subtraction value, in addition to the subtraction image (corrected subtraction image) that is generated in the embodiment as described above. In this case, in the process at Step S1050, the display control unit 105 may display the initial subtraction image and the corrected subtraction image side by side, or switch display of the images in accordance with an instruction that is given by the user. For example, it may be possible to normally display the corrected subtraction image, and display the initial subtraction image while the user is pressing a specific key. Furthermore, it may be possible to determine whether or not a cursor of the user designates the first part in the first medical image or the subtraction image based on the identification information on the part, displays the corrected subtraction image while the first part is being designated, and display the initial subtraction image in other cases. Moreover, similarly to a general image viewer, when a pixel value of a coordinate that is designated by the cursor of the user is displayed with text information at a predetermined display position (for example, four corners of an image display region, an information display region adjacent to the image display region, a diagonally lower part of the cursor, or the like), I may be possible to use the pixel value of the initial subtraction image for the display of the text information even when the corrected subtraction image is displayed as an image. Furthermore, it may be possible to display a pixel value that is not yet corrected and a corrected pixel value side by side. In this case, it may be possible to display both of the pixel value that is not yet corrected and the corrected pixel value only when the pixel values are different, and refrain from displaying both of the pixel values when the pixel values are the same. Moreover, it may be possible to change a display mode of the text information (change colors, change fonts, change sizes, or the like) between when the correction is performed and when the correction is not performed to notify the user that the correction is performed.

Furthermore, in the process at Step S1050, the subtraction image generation unit 104 may display only the initial subtraction image, and may give a notice of presence of the negative subtraction value that needs to be ignored, by an icon, text, or the like when a negative subtraction value is present in the first part on the displayed subtraction image. In this case, it may be possible to omit generation of the corrected subtraction image. Moreover, when the initial subtraction image is displayed, it may be possible to give a notice of presence of the negative subtraction value that needs to be ignored only while the cursor of the user is designating the first part on the first medical image or the initial subtraction image.

Alternatively, it may be possible to give a notice of presence of the negative subtraction value that needs to be ignored only while the cursor is designating a pixel that meets the predetermined condition (that is, a correction target) in the first part. Furthermore, it may be possible to display, as the text information, the pixel value of the corrected subtraction image when the pixel value of the coordinate that is designated by the cursor is displayed at a predetermined display position.

### Eighth Modification

In the process at Step S1050, to clarify a part for which each of the pixels of the generated subtraction image indicates a difference, the display control unit 105 may further display the identification information on the first part and the second part (or at least one of the first part and the second part) in a superimposed manner on the subtraction image. The identification information may be superimposed by using a predetermined color with high transparency or contour information on a region may be superimposed, so as to be distinguished from the subtraction image (represented by grayscale). Furthermore, it may be possible to superimpose region information on a corresponding part on the first medical image or the subtraction image only when the user overlays the cursor on the displayed subtraction image. Moreover, it may be possible to give a notice of a part corresponding to the coordinate that is designated by the cursor to the user by changing a design (color or type) of the cursor. Furthermore, it may be possible to display an icon that indicates a part, in the vicinity of the cursor or at a predetermined position in the display image.

Moreover, the display control unit 105 may perform display such that a region subjected to the correction process is clarified. Furthermore, the display control unit 105 may perform display such that a type of the correction process is clarified. In other words, the display control unit 105 may display the subtraction image such that a region that includes the corrected subtraction value as the pixel value of the subtraction image or a type of the correction process that is performed at the time of acquiring the corrected subtraction value can be identified. For example, the display control unit 105 may be configured to display an icon that indicates presence or absence or a type of the correction process. For example, it is possible to adopt a configuration in which an icon of “+” is displayed in the vicinity of a cursor when the cursor designates a region in which a negative value is being removed or attenuated. Similarly, it is possible to adopt a configuration in which an icon of “−” is displayed in the vicinity of a cursor when the cursor designates a region in which a positive value is being removed or attenuated. Alternatively, it is possible to adopt a configuration in which an icon that indicates presence or absence or a type of the correction process is displayed only when the cursor designates a pixel that is being subjected to the correction process.

### Ninth Modification

At Step S1040 in the present embodiment, when it is determined that the pixel of interest belongs to the first part, the subtraction image generation unit 104 generate the subtraction image by first calculating the initial subtraction value (Step S4021), and thereafter correcting the subtraction value (Step S2022). However, the method of generating the subtraction image is not limited to the example as described above. When the subtraction value for the first part is to be calculated, it may be possible to directly compare the pixel value of the first coordinate and the pixel value of the second coordinate for calculation of the subtraction value, instead of calculating the initial subtraction value and determining the polarity of the initial subtraction value. More specifically, when the pixel value of the second coordinate is larger than the pixel value of the first coordinate, it may be possible to set the subtraction value between the pixel values to zero or attenuates the subtraction value. With this configuration, it is possible to save time and effort to calculate and store the initial subtraction value.

In other words, the subtraction image generation unit 104 determines whether or not the pixel value of the first coordinate of the first medical image corresponding to the pixel of interest and the pixel value of the second coordinate of the second medical image corresponding to the first coordinate meet the predetermined condition, performs a correction process on the initial subtraction value in accordance with a determination result, and acquires a corrected subtraction value. In this case, determination on whether or not the pixel values of the first coordinate and the second coordinate meet the predetermined condition may be performed based on the initial subtraction value that is a difference between the pixel values, or may be performed by directly using the pixel values.

### Second Embodiment

An image processing apparatus according to a second embodiment is an apparatus that receives input of an existing subtraction image and generates a corrected subtraction image that is corrected in accordance with a part. In the following, only a difference from the first embodiment will be described.

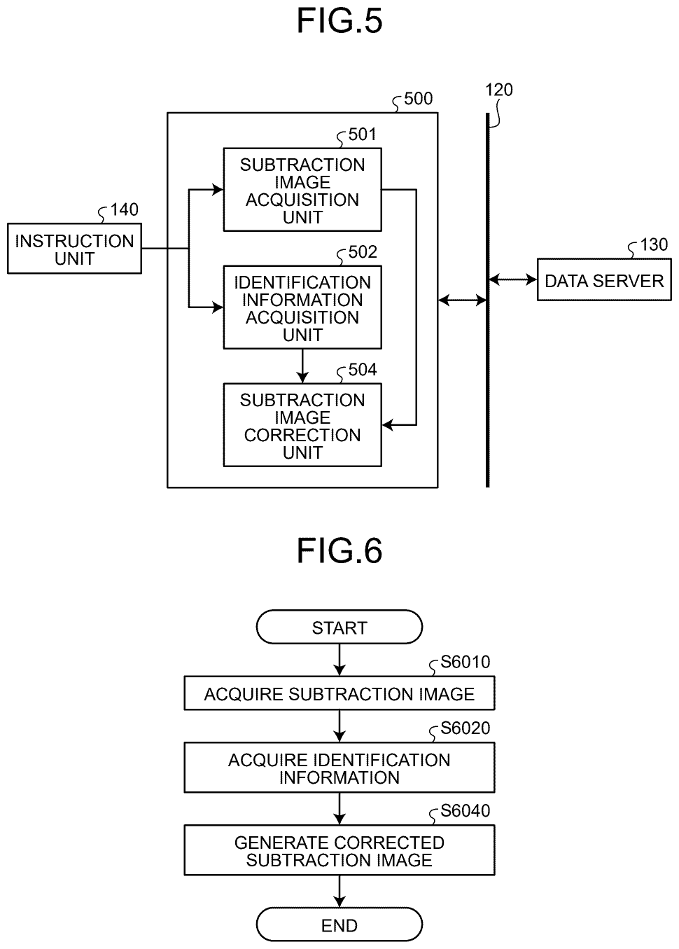

FIG. 5 is a diagram illustrating a configuration of an image processing system 30 according to the second embodiment. The image processing system 30 includes an image processing apparatus 500 and the data server 130. Meanwhile, similarly to the image processing system 10 illustrated in FIG. 1, the image processing system 30 may include the display unit 150.

The image processing apparatus 500 is an apparatus that generates a corrected subtraction image by adding correction to a subtraction image, and includes at least a subtraction image acquisition unit 501, an identification information acquisition unit 502, and a subtraction image correction unit 504. The subtraction image acquisition unit 501 acquires information on a subtraction image that is to be input to the image processing apparatus 500. The identification information acquisition unit 502 acquires identification information on a part that is drawn in the subtraction image. The subtraction image correction unit 504 generates a corrected subtraction image by adding correction to the subtraction image based on the identification information. The components are implemented by causing processing circuitry that is included in the image processing apparatus 500 to execute a program. The subtraction image acquisition unit 501 is an example of a subtraction image acquisition means. The identification information acquisition unit 502 is one example of the identification information acquisition means. The subtraction image correction unit 504 is an example of a subtraction image generation means.

Flow of process performed by image processing apparatus 500

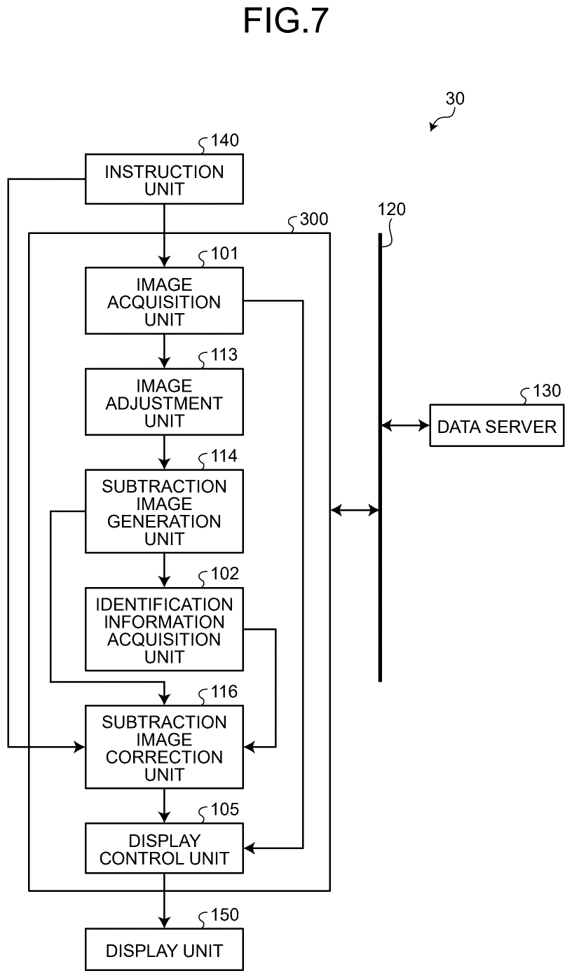

FIG. 6 is a flowchart illustrating the flow of an entire process performed by the image processing apparatus 500. S6010: Acquisition of subtraction image

At Step S6010, the subtraction image acquisition unit 501 acquires, from the data server 130, a subtraction image that is designated by a user via the instruction unit 140. Further, the acquired subtraction image is output to the subtraction image correction unit 504. It is assumed that the subtraction image according to the present embodiment is a subtraction image that is generated, in advance, from the first medical image and the second medical image that are obtained by imaging a subject at different times, and stored in association with the first medical image.

S6020: Acquisition of identification information

At Step S6020, the identification information acquisition unit 502 acquires, from the data server 130, identification information on a part that is associated with the subtraction image. Further, the acquired identification information is output to the subtraction image correction unit 504. It is assumed that the subtraction image according to the present embodiment is a label image of a part, which is generated in advance with respect to the first medical image, and stored in association with the first medical image.

S6040: Generation of corrected subtraction image

At Step S6040, the subtraction image correction unit 504 performs a correction process on the subtraction image based on the identification information on a part, and generates the corrected subtraction image. Further, the generated corrected subtraction image is stored in a storage unit (not illustrated).

The process that is performed by the subtraction image correction unit 504 at this step is approximately the same as the process that is performed by the subtraction image generation unit 104 at Step S1040 in the first embodiment, but the method of acquiring the initial subtraction value is different. Specifically, the process of calculating the initial subtraction value of the pixel of interest based on a difference between images at Step S4021 in the first embodiment is changed, at Step S4021 of the second embodiment, to a process of reading the initial subtraction value from the acquired subtraction image by the subtraction image acquisition unit 501. With this configuration, when the identification information on the pixel of interest of the subtraction image is identified as the first part, it is determined whether or not the pixel value of the pixel of interest meets the predetermined condition, and the corrected subtraction image is generated by performing a predetermined correction process corresponding to a determination result on the pixel value. The same applies to the case where the identification information on the pixel of interest is identified as the second part.

Thus, the image processing apparatus 500 performs the process.

According to the second embodiment, by performing correction in accordance with the part, it is possible to eliminate unneeded information that is included in the subtraction image.

### Third Embodiment

An image processing apparatus 300 according to a third embodiment is different from the image processing apparatus 100 of the first embodiment in that the image processing apparatus 300 includes an image adjustment unit 113 instead of the registration information acquisition unit 103, and includes a subtraction image generation unit 114 and a subtraction image correction unit 116 instead of the subtraction image generation unit 104.

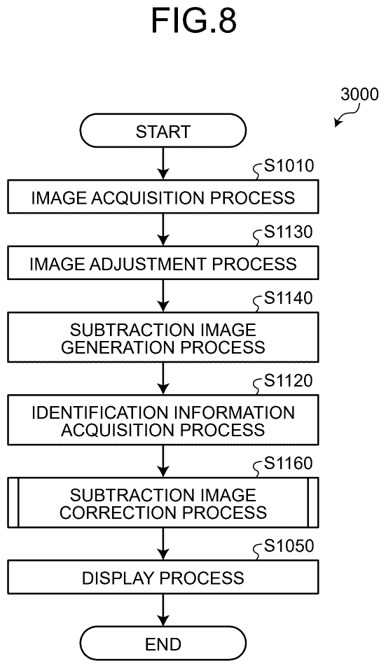

As illustrated in FIG. 7, the image processing apparatus 300 includes the image acquisition unit 101, the image adjustment unit 113, the subtraction image generation unit 114, the identification information acquisition unit 102, and the subtraction image correction unit 116. The image processing apparatus further includes the display control unit 105 that performs display control on the subtraction image that is corrected through a subtraction image correction process that is performed by the subtraction image correction unit 116 and displays the subtraction image on the display unit 150.

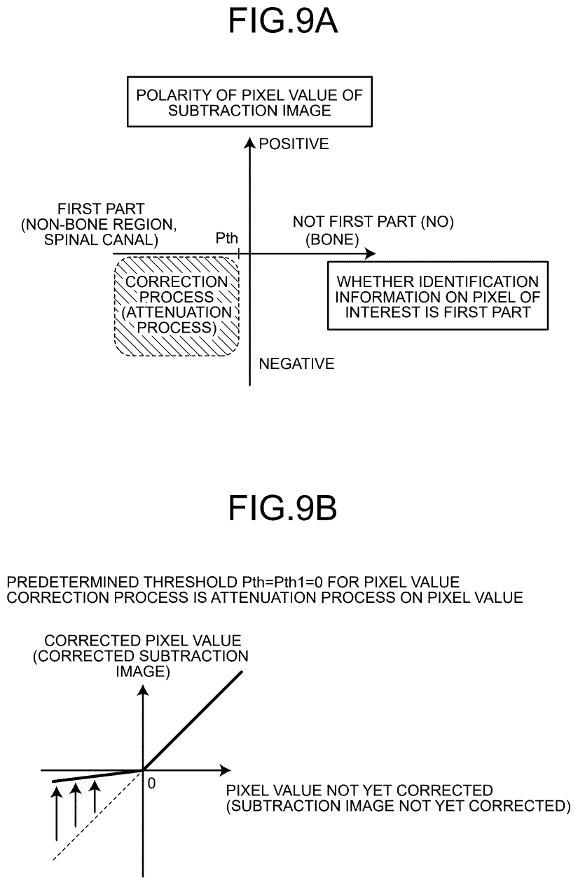

Furthermore, an image processing method 3000 according to the present embodiment includes, as illustrated in FIG. 8, Step S1010 that is an image acquisition process, Step S1130 that is an image adjustment process, Step S1140 that is a subtraction image generation process, Step S1120 that is an identification information acquisition process, and Step S1160 that is a subtraction image correction process. The image processing method 3000 further includes Step S1050 that is a display process of performing display control on the subtraction image that is corrected through a process of correcting the subtraction image at Step S1160, which is a subtraction image correction process, and displaying the subtraction image on the display unit 150.

Image adjustment unit 113

The image adjustment unit 113 adjusts at least one of a first image and a second image that are acquired by the image acquisition unit 101 at different time phases, such that one of the first image and the second image is made corresponding to the other one of the first image and the second image. Image adjustment that is performed by the image adjustment unit 113 includes at least a part of a deformation process, a rotation process, a registration process, a resolution conversion process, a tone adjustment process, a masking process, a trimming process, an angle-of-view increase process, and a positional reference acquisition process of acquiring information on a predetermined positional reference. The image adjustment unit 113 further has a mode for performing a registration process of aligning positions based on a predetermined positional reference. The predetermined positional reference includes an anatomical feature point and a landmark assigned on image.

In other words, the image processing apparatus 300 includes the image acquisition unit 101 that acquires the first image and the second image that are obtained by imaging the same subject at different times, and the image adjustment unit 113 that adjusts at least one of the first image and the second image such that one of the first image and the second image is made corresponding to the other one of the first image and the second image. Image adjustment operation that is performed by the image adjustment unit 113 is implemented on a computer by a program for executing the image adjustment process at Step S1130.

Subtraction image generation unit

The subtraction image generation unit 114 is configured to generate a subtraction image by calculating a subtraction value of the image for which an imaging time is temporally later with respect to the image, for which an imaging time is temporally earlier between the adjusted image and the other image among the first image and the second image. In other words, the subtraction image generation unit 114 is a means that calculates a subtraction value between two images with different time phases, at least one of which is subjected to the registration process by the image adjustment unit 113, and generates a subtraction image (third image).

The image processing system 30 to which the image processing apparatus 300 of the present embodiment is applied includes the image adjustment unit 113 that performs deformed registration, and the subtraction image generation unit 114 that generates a subtraction image between two images that are subjected to the deformed registration and that are associated with each other. With the components as described above, the image processing system 30 to which the image processing apparatus 300 is applied supports recognition of a change region of a current image, for which a degree of interest in recognition of a position of a disease region is high, with respect to a past image between the two images that are obtained at different time phases with respect to the same subject.

Meanwhile, the subtraction image generation unit 114 according to the present embodiment generates a subtraction image for two images at different time phases, which are subjected to adjustment performed by the image adjustment unit 113 but which are not subjected to a correction process performed by the subtraction image correction unit 116 (to be described later). In other words, the subtraction image (third image) that is generated by the subtraction image generation unit 114 is an initial subtraction image that has the initial subtraction value that is described in relation to the subtraction image generation unit 104 according to the first embodiment.

Identification information acquisition unit

The identification information acquisition unit 102 extracts at least any of anatomical parts from the temporally later image and the subtraction image (third image) and acquires identification information on the part, similarly to the first embodiment. In other words, the identification information acquisition unit 102 identifies an anatomical part such that the first part corresponds a region other than a bone. Furthermore, the identification information acquisition unit 102 identifies an anatomical part such that the first part corresponds to a spinal canal the region or an extraosseous region.

The identification information acquisition unit 102 of the present embodiment is configured to extract an anatomical part from at least any of the temporally later image and a subtraction image corresponding to the third image. It can be seen that the identification information acquisition unit 102 illustrated in FIG. 7 is configured to extract an anatomical part based on the subtraction image corresponding to the third image from the subtraction image generation unit 114. The identification information acquisition unit 102 is configured to extract an anatomical part based on the temporally later image (current image) that is not the temporal subtraction image, but a signal transmission path from the image adjustment unit 113 to the identification information acquisition unit 102 is omitted. Identification information acquisition process that is performed by the identification information acquisition unit 102 is implemented on a computer by a program for executing the identification information acquisition process at Step S1020. Subtraction image correction unit

The subtraction image correction unit 116 performs correction on the subtraction image (third image) that is generated by the subtraction image generation unit 114 based on whether or not the identification information on the pixel of interest in the subtraction image is the first part and whether or not the pixel value of the subtraction image is smaller than a predetermined threshold. The corrected temporal subtraction image that is adaptively corrected by the subtraction image correction unit 116 in accordance with the identification information and the pixel value of the subtraction image may be referred to as a fourth subtraction image in the present specification.

As illustrated in FIG. 7, the subtraction image correction unit 116 acquires the identification information on the pixel of interest from the identification information acquisition unit 102. The subtraction image correction unit 116 may replace the pixel of interest with a region of interest that includes a plurality of pixels that have anatomically common features, and handle the region of interest. In other words, the subtraction image correction unit 116 is a correction means for performing a correction process depending on whether or not the first part corresponds to an “internal spinal canal”.

Furthermore, as illustrated in FIG. 7, the subtraction image correction unit 116 is referred to as a correction means for adaptively performing a correction process depending on whether or not the pixel value of the subtraction image (third image) that serves as a determination criterion for the pixel value of the subtraction image is smaller than a predetermined threshold. The subtraction image correction unit 116 is able to acquire a predetermined threshold Pth via the instruction unit 140 that receives an instruction from a user. The predetermined threshold Pth may be selected from a list that is made as a menu, or it may be possible to adopt a threshold that is determined based on information, such as PACS, an electronic medical record, or an examination order.

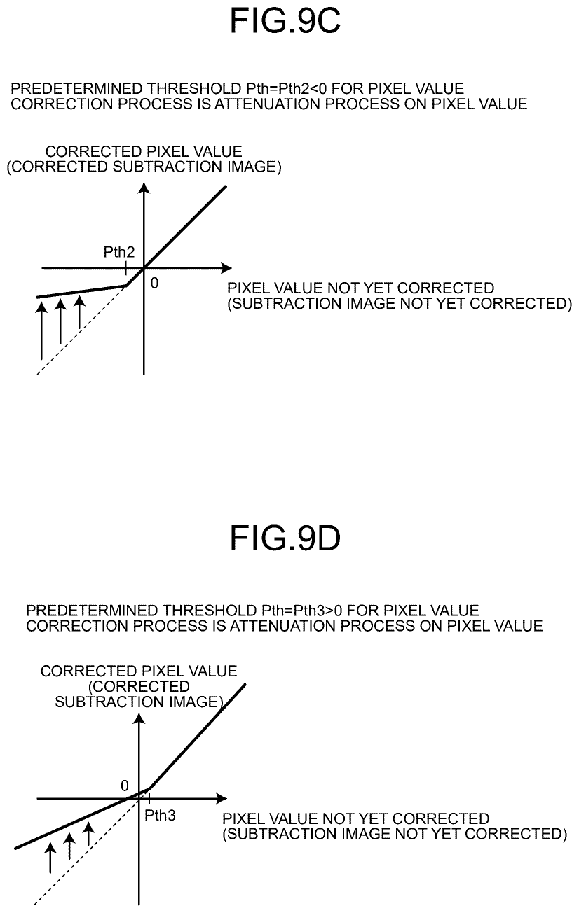

As illustrated in FIG. 9A to FIG. 9D, when the pixel of interest is identified as a spinal canal that is the first part, the subtraction image correction unit 116 corrects at least any of a pixel value of a pixel for which the pixel value of the pixel of interest POI is smaller than the predetermined threshold Pth, and a pixel value of a pixel for which the pixel value of the pixel of interest POI is larger than the predetermined threshold Pth. In this case, the subtraction image correction unit 116 corrects the subtraction image such that visibility of a pixel for which the pixel value of the pixel of interest POI is smaller than the predetermined threshold Pth is relatively reduced as compared to visibility of a pixel for which the pixel value of the pixel of interest POI is larger than the predetermined threshold Pth.

As illustrated in FIG. 9A to FIG. 9D, the subtraction image correction unit 116 and the subtraction image correction process at Step S1160 performs correction such that a component that corresponds to the internal spinal canal that is a non-bone region among osteolysis signals on the temporal subtraction image, for which the pixel value of the subtraction image is smaller than the predetermined threshold and a CT value it temporally reduced, is attenuated.

The predetermined threshold Pth is appropriately designated by a background noise level of an X-ray imaging system, a quantization noise level that is derived from an image reconstruction process, a minimum tone width of a luminance contour on display including a luminance level of zero, or the like, with respect to the subtraction value that is the pixel value of the temporal subtraction image. From the viewpoint of ensuring reproducibility of an original image and reducing an influence on interpretation accuracy of an interpretation doctor, it is preferable to set the predetermined threshold Pth to a negative value at a noise level around the luminance of zero as described above or a minimum tone unit. FIG. 9A and FIG. 9C illustrate modes of the correction process operation that includes the attenuation correction process of the subtraction image correction unit 116 for which the predetermined threshold Pth is set to a negative value (Pth2<0) in the third embodiment. Further, FIG. 9B illustrates a mode of the correction process operation that includes the attenuation correction process of the subtraction image correction unit 116 for which the predetermined threshold Pth is set to zero (Pth1=0) in the third embodiment. Furthermore, FIG. 9D illustrates a mode of the correction process operation that includes the attenuation correction process of the subtraction image correction unit 116 for which the predetermined threshold Pth is set to a positive value (Pth3>0).

As illustrated in FIG. 9B to FIG. 9D, similarly to the subtraction image generation unit 104 of the first embodiment, when the pixel of interest POI is identified as the internal spinal canal that is the first part and the pixel value of the pixel of interest POI is smaller than the predetermined threshold Pth, the subtraction image correction unit 116 performs a differential attenuation process of multiplying the pixel value of the pixel of interest POI by a predetermined coefficient a that is equal to or larger than zero and smaller than one.

The subtraction image correction unit 116 does not perform the differential attenuation process on the pixel value of the pixel of interest POI when the pixel of interest POI is not identified as the first part (the internal spinal canal) or when the pixel value of the pixel of interest POI is larger than the predetermined threshold Pth. Correction process operation that is performed on the subtraction image by the subtraction image correction unit 116 is implemented on a computer by a program for executing the subtraction image correction process at Step S1160.

### Fourth Embodiment

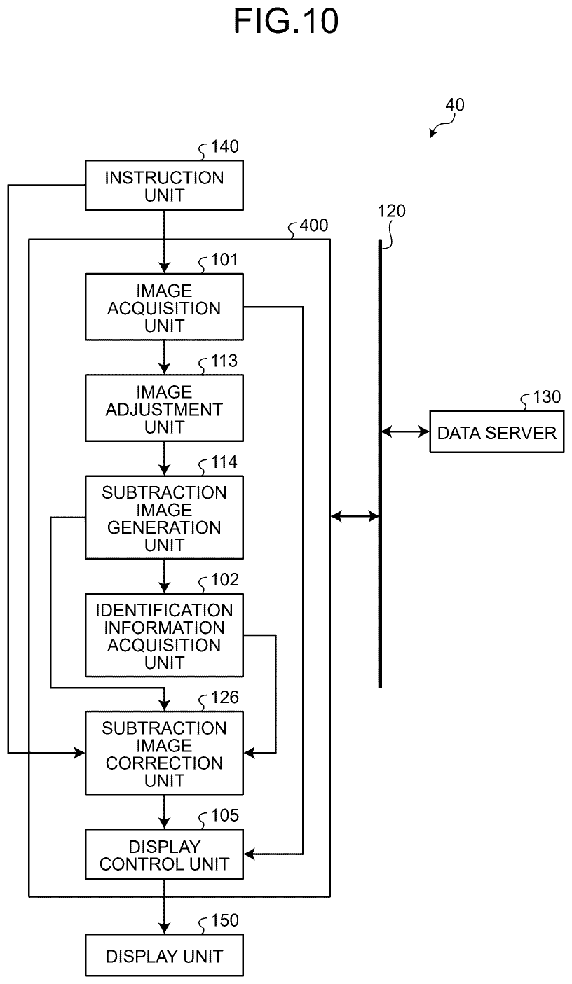

FIG. 10 is a diagram illustrating a configuration of an image processing system 40 according to the fourth embodiment. As illustrated in FIG. 10, an image processing apparatus 400 according to a fourth embodiment is different from the image processing apparatus 300 of the third embodiment in that the image processing apparatus 400 includes a subtraction image correction unit 126 instead of the subtraction image correction unit 116.

An image processing method (not illustrated) according to the fourth embodiment is different from the image processing method 3000 of the third embodiment in that the image processing method includes a subtraction image correction process (not illustrated) of correcting a display mode other than attenuation or increase of the pixel value instead of the subtraction image correction process at Step S1160.

Subtraction image correction unit

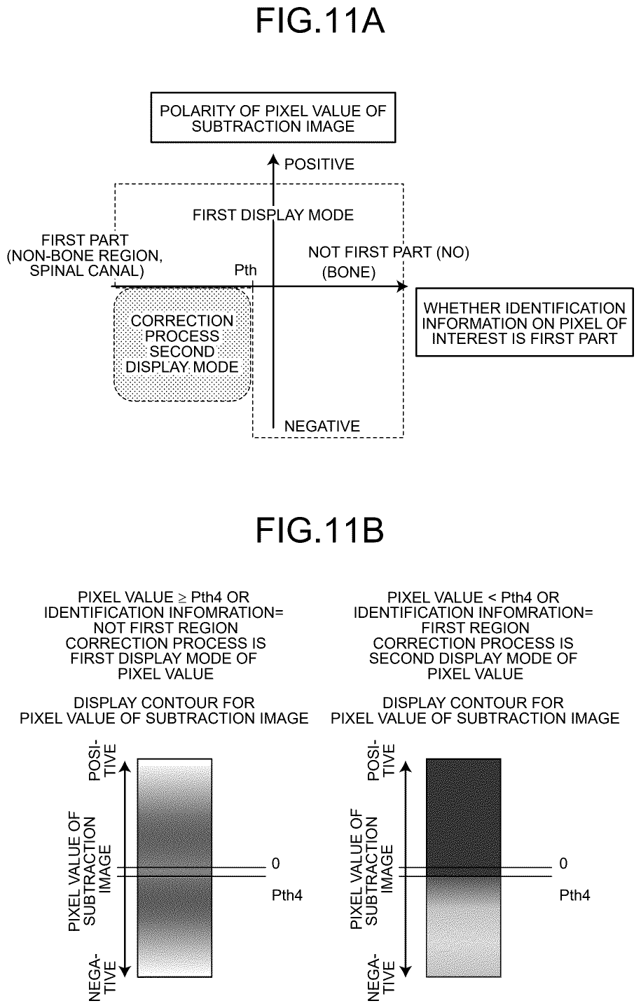

As illustrated in FIG. 11A and FIG. 11B, the subtraction image correction unit 126 corrects the subtraction image such that a display mode of a pixel for which the pixel value of the pixel of interest POI that is identified as the internal spinal canal that is the first part is smaller than the predetermined threshold Pth becomes different from a display mode of a pixel for which the pixel value that is identified as not being the first part is smaller than the predetermined threshold Pth. For example, when the pixel value is larger than the predetermined threshold Pth or identified as not being the first part, the subtraction image correction unit 126 corrects the subtraction image in accordance with a display contour illustrated on the left side in FIG. 11B. In contrast, when the pixel value is smaller than the predetermined threshold Pth and identified as the first part, the subtraction image correction unit 126 corrects the subtraction image in accordance with a display contour illustrated on the right side in FIG. 11B. Meanwhile, FIG. 11B illustrates a negative value (Pth4<0) as the predetermined threshold Pth. In the present embodiment, the subtraction image correction unit 126 changes, between a first display mode and a second display mode, a grayscale contour (contour as an explanatory note) with respect to a luminance value on the subtraction image, but it is possible to appropriately adopt a different display mode, such as a color palette, a lighting-flashing pattern, saturation (chromatic color or achromatic color), color temperature, or chromaticity (cool color to warm color).

With this configuration, similarly to the image processing apparatus of the first embodiment to the third embodiment, the image processing apparatus 400 of the fourth embodiment displays, for a user including an interpretation doctor, an osteolysis signal that has occurred in a non-bone region, such as the internal spinal canal, in a distinguishing manner from an osteolysis signal that has occurred in a bone region, and supports interpretation and identification.

The term “processor” used in the explanation as described above indicates circuitry, such as a CPU, a Graphics Processing Unit (GPU), an Application Specific Integrated Circuit (ASIC), or a programmable logic device (for example, a Simple Programmable Logic Device (SPLD), a Complex programmable Logic Device (CPLD), or a Field Programmable Gate Array (FPGA)). Further, the program may be directly incorporated in the circuitry of the processor, instead of being stored in the storage unit. In this case, the processor reads and executes the program that is implemented in the circuitry, and implements the functions.

The components of the apparatuses according to the embodiments as described above are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. Further, for each processing function performed by each apparatus, all or any part of the processing function may be implemented by a CPU and a program analyzed and executed by the CPU or may be implemented as hardware by wired logic.

Furthermore, the image processing method described in the embodiments as described above may be implemented by causing a computer, such as a personal computer or a workstation, to execute a program that is prepared in advance. The program may be distributed via a network, such as the Internet. Moreover, the program may be recorded in a non-transitory computer readable recording medium, such as a hard disk, a flexible disk (FD), a compact disc read only memory (CD-ROM), a magneto-optical disk (MO), or a digital versatile disk (DVD), and may be executed by being read from the recording medium by a computer.

According to at least one of the embodiments as described above, it is possible to eliminate unneeded information that is included in a subtraction image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
processing circuitry configured to
acquire a first image and a second image that are obtained by imaging a subject at different times;
acquire identification information on a part at a plurality of coordinates in the first image; and
generate a subtraction image between the first image and the second image such that a corrected subtraction value, that is obtained by performing a predetermined correction process, is adopted as a pixel value of a pixel of interest, the predetermined correction process being performed on an initial subtraction value that represents a difference between a pixel value at a first coordinate in the first image corresponding to the pixel of interest and a pixel value at a second coordinate in the second image corresponding to the first coordinate, when the pixel of interest is identified as a first part based on the identification information, the predetermined correction process corresponding to a determination result of determination on whether or not the pixel value at the first coordinate and the pixel value at the second coordinate meet a predetermined condition.

2. The image processing apparatus according to claim 1, wherein the processing circuitry is configured to determines whether or not the pixel value at the first coordinate and the pixel value at the second coordinate meet the predetermined condition based on the initial subtraction value.

3. The image processing apparatus according to claim 2, wherein the predetermined condition is one of a condition on whether or not the initial subtraction value is zero or equal to or smaller than a first threshold that is around zero and a condition on whether or not the initial subtraction value is zero or smaller than the first threshold that is around zero.

4. The image processing apparatus according to claim 1, wherein the predetermined correction process is a process of setting the corrected subtraction value to one of zero and a value around zero when the pixel value at the first coordinate and the pixel value at the second coordinate meet the predetermined condition.

5. The image processing apparatus according to claim 1, wherein the predetermined correction process is a process of setting the corrected subtraction value to a value that is obtained by attenuating the initial subtraction value when the pixel value at the first coordinate and the pixel value at the second coordinate meet the predetermined condition.

6. The image processing apparatus according to claim 1, wherein the predetermined correction process is a process of setting the corrected subtraction value to a value that is obtained by enhancing the initial subtraction value when the pixel value at the first coordinate and the pixel value at the second coordinate do not meet the predetermined condition.

7. The image processing apparatus according to claim 1, wherein the first part is at least one of a spinal canal and a vertebra peripheral region.

8. The image processing apparatus according to claim 1, wherein the processing circuitry is configured not to perform the predetermined correction process when the pixel of interest is identified as a second part based on the identification information.

9. The image processing apparatus according to claim 8, wherein the second part is a bone region.

10. The image processing apparatus according to claim 1, wherein the processing circuitry is configured not to perform the predetermined correction process when the pixel of interest is identified as a background region based on the identification information.

11. The image processing apparatus according to claim 1, wherein the processing circuitry is configured to display, on a display unit, the subtraction image such that a region that has the corrected subtraction value as a pixel value in the subtraction image is identifiable.

12. The image processing apparatus according to claim 11, wherein the processing circuitry is configured to display the subtraction image such that a type of a correction process that is performed when the corrected subtraction value is acquired is identifiable.

13. The image processing apparatus according to claim 3, wherein the processing circuitry is configured to extract a region of interest by performing, with use of a second threshold that is larger than the first threshold, a threshold process on one of the initial subtraction value and the corrected subtraction value among a plurality of pixels of the subtraction image that is identified as the first part based on the identification information.

14. An image processing apparatus comprising:
processing circuitry configured to
acquire a subtraction image between a first image and a second image that are obtained by imaging a subject at different times;
acquire identification information on a part at a pixel of interest of the subtraction image;
determine whether or not a pixel value of the pixel of interest of the subtraction image meets a predetermined condition when the pixel of interest is identified as a first part based on the identification information; and
generate a corrected subtraction image by performing a predetermined correction process corresponding to a determination result on the pixel value.

15. An image processing method comprising:
acquiring a first image and a second image that are obtained by imaging a subject at different times;
acquiring identification information on a part at a plurality of coordinates in the first image; and
generating a subtraction image between the first image and the second image such that a corrected subtraction value, that is obtained by performing a predetermined correction process, is adopted as a pixel value of a pixel of interest, the predetermined correction process being performed on an initial subtraction value that represents a difference between a pixel value at a first coordinate in the first image corresponding to the pixel of interest and a pixel value at a second coordinate in the second image corresponding to the first coordinate, when the pixel of interest is identified as a first part based on the identification information, the predetermined correction process corresponding to a determination result of determination on whether or not the pixel value at the first coordinate and the pixel value at the second coordinate meet a predetermined condition.

16. A non-transitory computer readable recording medium having stored therein a program that causes a computer to execute the image processing method according to claim 15.

17. An image processing apparatus comprising:
processing circuitry configured to
acquire a first image and a second image that are obtained by imaging a same subject at different times;
adjust at least one of the first image and the second image such that one of the first image and the second image is made corresponding to another one of the first image and the second image;
generate a subtraction image by calculating a subtraction value of an image for which an imaging time is temporally later with respect to an image for which an imaging time is temporally earlier between the adjusted image and the other image;
extract an anatomical part from at least any of the temporally later image and the subtraction image;
acquire identification information on the anatomical part; and
correct the subtraction image based on a correction method corresponding to the identification information, wherein
the processing circuitry is configured to perform correction in accordance with whether or not the identification information on a pixel of interest in the subtraction image is a first part and whether or not a pixel value of the subtraction image is smaller than a predetermined threshold.

18. The image processing apparatus according to claim 17, wherein when the pixel of interest is identified as the first part, the processing circuitry is configured to correct at least one of a pixel value of a pixel for which the pixel value is smaller than the predetermined threshold and a pixel value of a pixel for which the pixel value is larger than the predetermined threshold such that visibility of a pixel for which the pixel value is smaller than the predetermined threshold is relatively reduced as compared to visibility of a pixel for which the pixel value is larger than the predetermined threshold.

19. The image processing apparatus according to claim 17, wherein when the pixel of interest is identified as the first part and the pixel value is smaller than the predetermined threshold, the processing circuitry is configured to perform a differential attenuation process of multiplying the pixel value by a predetermined coefficient that is equal to or larger than zero and smaller than one.

20. The image processing apparatus according to claim 19, wherein when the pixel of interest is identified as not being the first part or when the pixel value is equal to or larger than the predetermined threshold, the processing circuitry is configured not to perform the differential attenuation process on the pixel value.

21. The image processing apparatus according to claim 17, wherein the processing circuitry is configured to correct the subtraction image such that a display mode of a pixel for which the pixel value that is identified as the first part is smaller than the predetermined threshold becomes different from a display mode of a pixel for which the pixel value that is identified as not being the first part is smaller than the predetermined threshold.

22. The image processing apparatus according to claim 17, wherein the predetermined threshold is zero.

23. The image processing apparatus according to claim 17, wherein the processing circuitry is configured to identify an anatomical part such that the first part corresponds to a region other than a bone.

24. The image processing apparatus according to claim 17, wherein the processing circuitry is configured to identify an anatomical part such that the first part corresponds to one of a spinal canal region and an extraosseous region.

25. The image processing apparatus according to claim 17 wherein the processing circuitry is configured to perform adjustment that includes at least one of a deformation process, a rotation process, a registration process, a resolution conversion process, a tone adjustment process, a masking process, a trimming process, and an angle-of-view increase process.
